(19) United States
(12) Patent Application Publication
(10) Pub. No.: US 2022/0155865 A1
(43) Pub. Date: May 19, 2022

(54) SYSTEMS AND METHODS FOR A COMPENSATORY HAND-BASED DEVICE TO PROVIDE TEMPERATURE FEEDBACK

(71) Applicants: Arizona Board of Regents on Behalf of Arizona State University, Tempe, AZ (US); Dignity Health, San Francisco, CA (US)

(72) Inventors: Mitul Magu, Morrisville, NC (US); Jeremy Palmiscno, Phoenix, AZ (US); Jenna Zellner, Phoenix, AZ (US); Yatiraj Shetty, Tempe, AZ (US); Sharanya Parameshwar Hebbar, Tempe, AZ (US); Aditya Srivastav, Tempe, AZ (US); Krishna Koparde, Tempe, AZ (US); Ishan Chavan, (US); Sheena Benson, Phoenix, AZ (US)

(21) Appl. No.: 17/531,436

(22) Filed: Nov. 19, 2021

Related U.S. Application Data
(60) Provisional application No. 63/115,855, filed on Nov. 19, 2020.

(51) Int. Cl. G06F 3/01; G01K 7/42; G08B 7/06; G01D 7/00

(52) U.S. Cl. CPC G06F 3/014; G01K 7/42; G01D 7/007; G08B 7/06; G01D 7/005; G06F 3/016

(57) ABSTRACT

Various embodiments of a wearable device for detecting temperature of objects when in close proximity or in direct contact with an object and providing visual, audio and haptic feedback if an adverse temperature is detected are disclosed herein.

### CROSS-REFERENCE TO RELATED APPLICATIONS

This is a non-provisional application that claims benefit to U.S. Provisional Patent Application Ser. No. 63/115,855 filed 19 Nov. 2020, which is herein incorporated by reference in its entirety.

### FIELD

The present disclosure generally relates to sensory substitution devices, and in particular, to a system and associated method for providing temperature feedback of a surface to a user.

### BACKGROUND

Individuals who experience a loss of sensation in the upper extremity after a neurological injury, such as a cardiovascular attack, spinal cord injury, diabetic neuropathy, and/or brachial plexus injury often lose their ability to sense a temperature of objects when in close proximity or in direct contact. This lack of awareness of potentially harmful stimuli can affect aspects of daily life such as cooking or being outside in extreme heat or cold. Individuals who have difficulty judging how hot or cold a surface may be can tend to hold onto hot or cold objects which can result in tissue damage. Moreover, some temperature sensing gloves are available for automotive and emergency purposes but are too bulky for everyday applications.

It is with these observations in mind, among others, that various aspects of the present disclosure were conceived and developed.

### BRIEF DESCRIPTION OF THE DRAWINGS

FIG. 1A is an illustration showing a palm side of a device for providing temperature feedback;

FIG. 1B is an illustration showing a dorsal side of the device of FIG. 1A;

FIG. 2 is an illustration showing the device of FIG. 1A providing feedback to a user;

FIG. 3 is a simplified block diagram showing various components of the device of FIG. 1A;

FIG. 4 is a decision tree showing a decision process for providing temperature feedback by the device of FIG. 1A;

FIG. 5 is a process flow showing a method of operation of the device of FIG. 1A;

FIGS. 6A and 6B are illustrations showing one embodiment of the device of FIG. 1A; and

FIG. 7 is an is a simplified diagram showing an exemplary computing system for implementation of the controller of FIG. 3.

Corresponding reference characters indicate corresponding elements among the view of the drawings. The headings used in the figures do not limit the scope of the claims.

### DETAILED DESCRIPTION

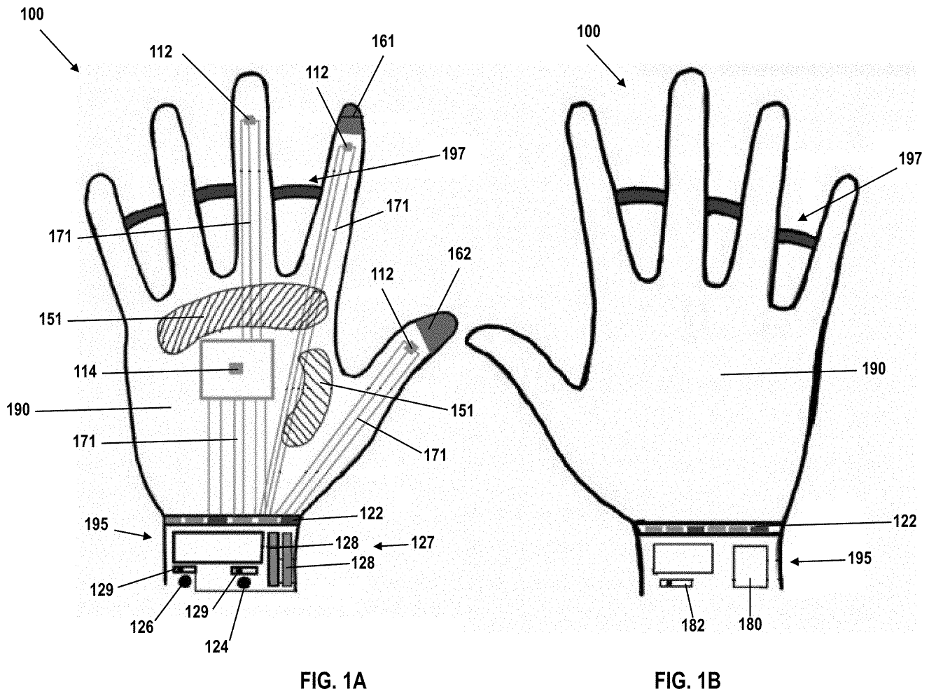

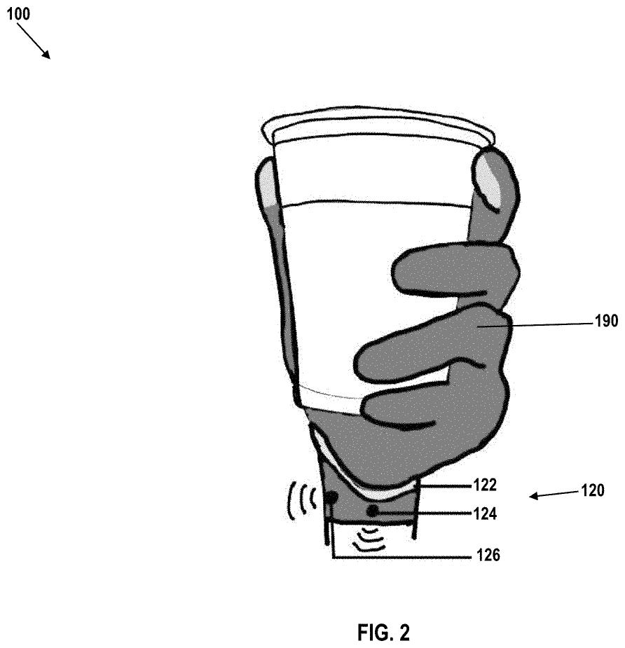

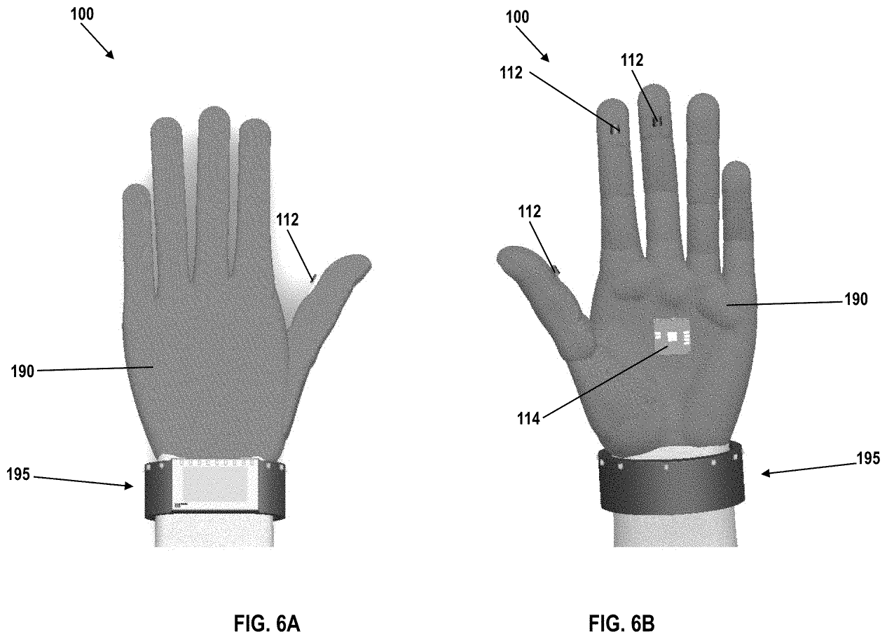

Various embodiments of a wearable device for sensing a temperature of objects when in close proximity or in direct contact with an object are described herein. A user of the device is provided with three different forms of feedback—visual, auditory and haptic, which can be modified in intensity to match the user's abilities and preferences. In some embodiments, the device is configured to be worn on the hand of a user and includes a combination of contact and non-contact sensors with a wide temperature sensitivity range. The device further includes a combination of audio, visual and haptic feedback to help users be aware of the temperature of objects in their vicinity. Referring to the drawings, embodiments of a wearable device for sensing the temperature of objects are illustrated and generally indicated as 100 in FIGS. 1-7.

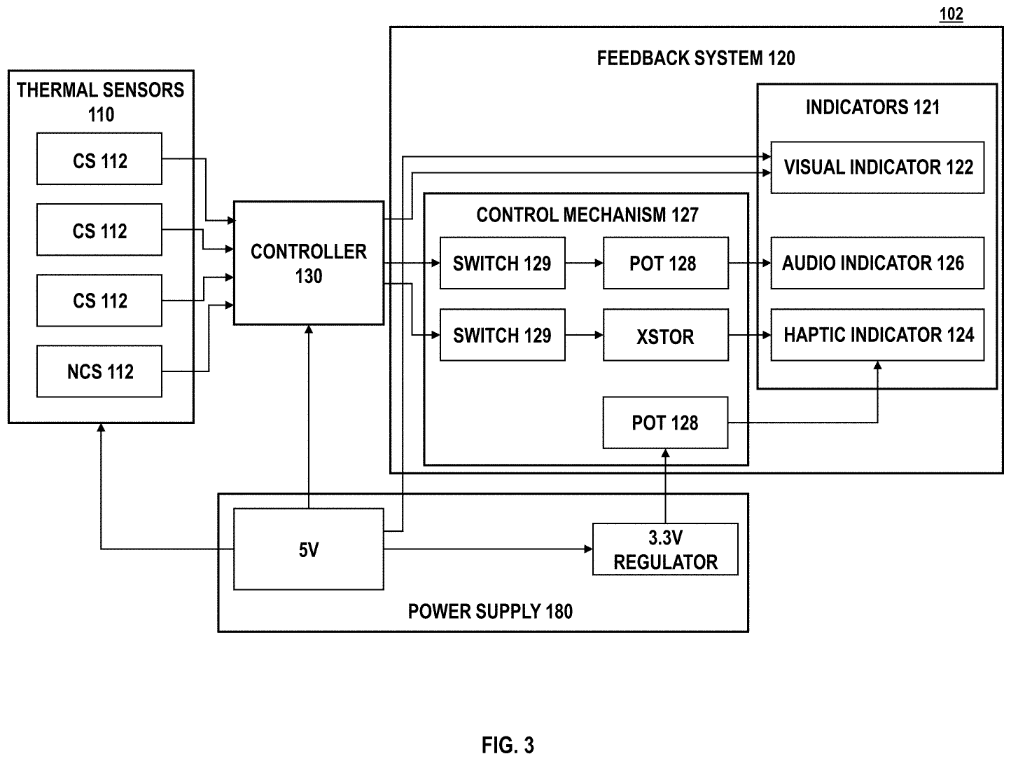

As discussed above and shown in FIGS. 1A-3, the wearable device 100 in some embodiments defines a glove portion 190 configured to receive a hand of the user and associated hardware 102 for thermal sensing and feedback. Referring to FIG. 1A and 3, hardware 102 includes a plurality of thermal sensors 110 including one or more contact sensors 112 and one or more non-contact sensors 114 to determine a temperature of objects in the vicinity of the hardware 102. In some embodiments, with the exception of the thermal sensors 110, the hardware 102 is housed in a wrist console 195. The wearable device 100 further includes a feedback system 120 having one or more visual indicators 122, one or more haptic indicators 124 and one or more audio indicators 126 which alert the user if one of the plurality of thermal sensors 110 detect a temperature within a predetermined range. As further shown, the feedback system 120 of the wearable device 100 includes a control mechanism 127 to vary a volume and intensity of the respective visual, haptic and audio indicators 122, 124 and 126. In some embodiments, the wearable device 100 further includes a controller 130 in communication with the thermal sensors 110 and feedback system 120 of the wearable device 100 to facilitate communication and operation.

Referring directly to FIGS. 3-6B, hardware 102 onboard the wearable device 100 includes thermal sensors 110 in communication with a feedback system 120 including the plurality of respective visual, haptic and audio indicators 122, 124 and 126 that are configured to alert the user if the thermal sensors 110 detect a temperature within a predetermined range. The thermal sensors 110 communicate with the feedback system 120 by a controller 130. In some embodiments, the wearable device 100 further includes a power supply 180 in communication with a charging module (not shown) configured to provide power to components of the wearable device 100. In some embodiments, the feedback system 120 includes a control mechanism 127 configured to control volume and intensity of the feedback system 120. The control mechanism 127 may in some embodiments include a plurality of potentiometers 128 each respectively configured to control a volume of an audio indicator 126 and an intensity of a haptic indicator 124 and visual indicator 122. The control mechanism 127 may further include one or more switches 129 configured to turn the respective visual, haptic and audio indicators 122, 124 and 126 on or off.

As shown in FIG. 1A, the glove portion 190 further includes one or more friction pads 151 across the palm of the glove portion 190 to aid in gripping objects. In some embodiments, the glove portion 190 further includes a first conductive pad 161 located on an index finger of the glove portion 190 and a second conductive pad 162 located on thumb of the glove portion 190 that are each configured to enable use of a capacitive touch screen. In some embodiments, the glove portion 190 further includes one or more pull-off loops 197 connecting the fingers of the glove portion 190 to allow for ease of removal of the wearable device 100.

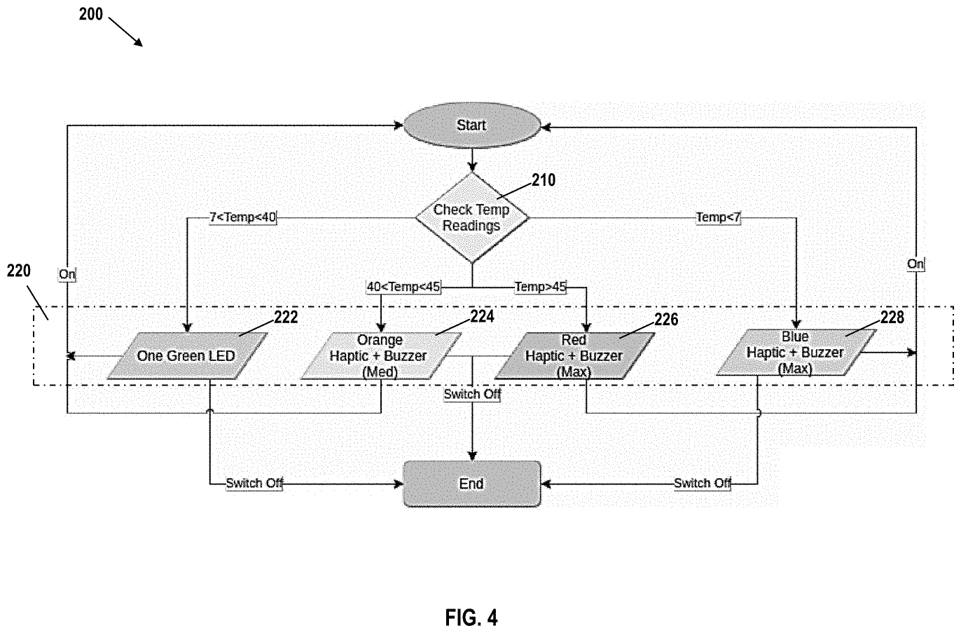

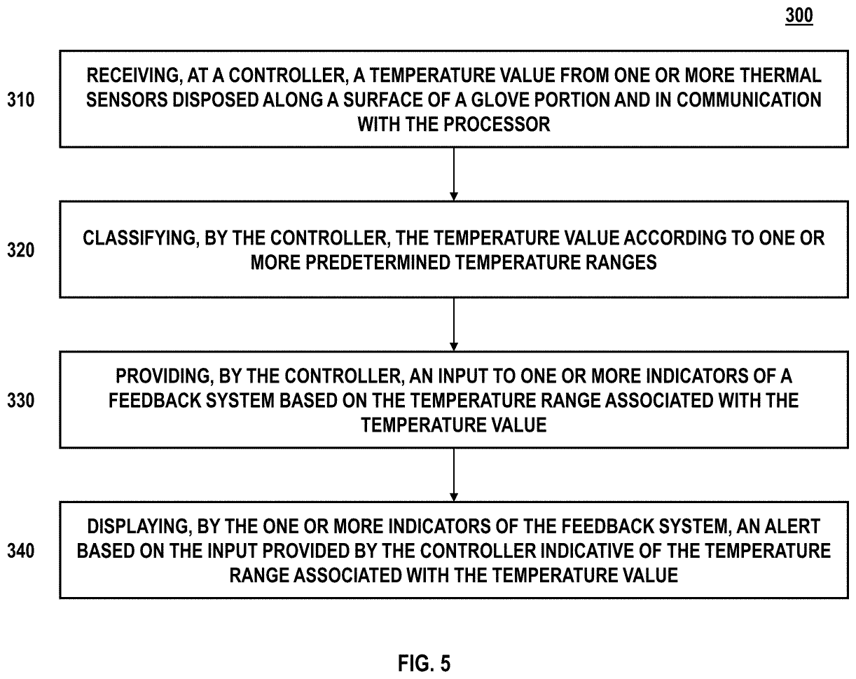

Referring to FIGS. 3-5, in some embodiments the controller 130 is onboard or otherwise in communication with the wearable device 100 and is operable to receive data indicative of a temperature from the one or more thermal sensors 110 and communicate with the feedback system 120 to provide feedback to the user. FIGS. 4 and 5 illustrate a decision tree 200 and corresponding process flow 300 facilitated by the controller 130 for providing feedback to the user in response to data received by the one or more thermal sensors 110. Blocks 310 and 320 of process flow 300 (FIG. 5) correspond with block 210 of decision tree 200 (FIG. 4). Blocks 330 and 340 of process flow 300 correspond with block 220 of decision tree 200. As shown in block 310, the controller 130 receives a temperature value from one or more thermal sensors 110 disposed along a surface of the glove portion 190. At block 320, the controller 130 classifies, by the controller 130, the temperature value according to one or more predetermined temperature ranges. In particular, the temperature value is classified into one of four ranges: extreme cold (<7° C.), safe (7° C.<Temp<40° C.), heat warning (40° C.<Temp<45° C.) and extreme heat (>45° C.), but other ranges and granularities can be selected for other embodiments. At block 330 of process flow 300, the controller 130 provides an input to one or more indicators 121 of the feedback system 120 based on the temperature range associated with the temperature value. At block 340, the system 100 displays, by the one or more indicators 121 of the feedback system 120, an alert based on the input provided by the controller 130 indicative of the temperature range associated with the temperature value. In particular, the feedback system 120 displays a different combination of indicator volume, intensity, and colors in response to the temperature value received by the one or more thermal sensors 110.

At block 222 of decision tree 200, the controller 130 has classified the temperature value within the “safe” range. The visual indicator 122 of the feedback system 120 displays a first color or spectrum of colors indicative of the “safe” range in response to a corresponding input from the controller 130. In an example embodiment, the first color is green, and no haptic or audio feedback is provided from the haptic indicator 124 or audio indicator 126 when the temperature is in the “safe” range.

At block 224 of decision tree 200, the controller 130 has classified the temperature value within the “warning” range. As a result, the visual indicator 122 of the feedback system 120 displays a second color or spectrum of colors indicative of the “heat warning” range in response to a corresponding input from the controller 130. In the example embodiment, the second color is orange or yellow, and haptic and audio feedback is provided at medium intensity from the haptic indicator 124 and audio indicator 126 if the temperature is in the “heat warning” range.

At block 226 of decision tree 200, the controller 130 has classified the temperature value within the “extreme heat” range. As a result, the visual indicator 122 of the feedback system 120 displays a third color or spectrum of colors indicative of the “extreme heat” range in response to a corresponding input from the controller 130. In the example embodiment, the third color is red and haptic and audio feedback is provided at maximum intensity from the haptic indicator 124 and audio indicator 126 if the temperature is in the “extreme heat” range.

At block 228, the controller 130 has classified the temperature value within the “extreme cold” range. As a result, the visual indicator 122 of the feedback system 120 displays a fourth color or spectrum of colors indicative of the “extreme cold” range in response to a corresponding input from the controller 130. In the example embodiment, the third color is blue and haptic and audio feedback is provided at maximum intensity from the haptic indicator 124 and audio indicator 126 if the temperature is in the “extreme cold” range. If the wearable device 100 or indicators 122, 124 and 126 of the feedback mechanism 120 are turned off, then the process 300 ends. Otherwise, the process 300 is iteratively repeated to allow continual temperature feedback to the user; when the feedback system 120 reacts to the temperature in block 330 the process 300 returns to block 310 to determine the temperature again.

In some embodiments, the visual indicators 122 are operable to display one or a spectrum of colors to indicate a relative temperature value to aid the user in discerning the temperature of an object. For instance, a colder object that is still within the “safe” range may cause the visual indicators 122 to show a blue-green color. In contrast, a warmer object that is still within the “safe” range may cause the visual indicators 122 to show a yellow-green color. A room-temperature object may cause the visual indicators 122 to show a pure green color. In some embodiments, the visual indicators 122 may be part of a digital display configured to display various screens indicative of the detected temperature range.

Further, in some embodiments, the haptic indicator 124 is operable to display variable types of vibration feedback to the user. For instance, the haptic indicator 124 can vary an intensity of vibration and a pattern of vibration corresponding to the relative temperature value or range. Similarly, in some embodiments, the audio indicator 126 is operable to display variable types of audio feedback to the user. For instance, the audio indicator 126 can vary an intensity of sound and or a pattern of sound corresponding to the relative temperature value or range. The potentiometers 128 enable manual adjustment of intensity for the haptic indicator 124 or the audio indicator 126 and can in some embodiments adjust an intensity of the visual indicators 122 as well.

In one particular embodiment, such as the embodiment shown in FIGS. 3-6B, the plurality of thermal sensors 110 of the wearable device 100 includes a plurality of contact thermal sensors 112 (for example, a TMP36 contact thermal sensor), a non-contact thermal sensor 114 (for example, TMP006 non-contact infrared thermopile sensor), the feedback system 120 including the plurality of visual indicators 122 (for example, one or more RGB LEDs) for visual feedback, the audio indicator 126 (for example, a 1536 buzzer) for audio feedback, and the haptic indicator 124 (for example, a ROBO 8449 vibrational motor) for haptic feedback. In the embodiment shown, the wearable device 100 includes three contact thermal sensors 112 respectively placed on the thumb, forefinger and middle finger of the glove portion 190, as shown in FIG. 1. The contact thermal sensors 112 detect and read the temperature of anything on its surface. The non-contact thermal sensor 114 is located in the middle of the palm and can detect temperature of objects in close proximity of the wearable device 100. The controller 130 is powered by the power supply 180 that can include a 5V lithium-ion polymer battery coupled with a battery charging circuit. In the embodiment shown, the power supply 180 can additionally include one or more voltage regulators to provide appropriate voltage to components of the wearable device 100. In some embodiments, the aforementioned components are placed on a wrist console 195 and stitched to the glove portion 190 in a way that wraps around the user's wrist and does not hamper comfort or usability. This wrist console 195 is what houses the majority of the hardware 102 of the device with the exception of the sensors 110. This has been done to ensure that no component of the wearable device 100 prevents any kind of motion that the user wants to perform with their hands. In some embodiments, the wrist console 195 is hook-and-loop-adjustable to provide a customized fit to each user. In other embodiments, other fastening means can be used such as a buckle, elastic, a drawstring, or a plurality of snaps. The visual indicators 122 are positioned around the wrist console 195 on both sides of the hand to ensure that the user can always have visual feedback in the field of vision while using the wearable device 100. In some embodiments, the fabrics used to make the glove portion 190 may be any fabric suitable for gloves. The fabric may include bamboo fibers, chloroprene, cotton, leather, neoprene, nylon, polyester, polyurethane, polyvinyl chloride, spandex, synthetic leather, silk, or any combination of these fabrics. In other embodiments, the fabrics used to make the glove portion 190, are polyester-nylon-spandex blend and cotton-spandex blend to ensure lightweight and breathability. Since the glove portion 190 can lead to sweating in the palm over a long time, these fabrics ensure that the sweating is not excessive. Waterproofing spray is applied to the wrist console 195 and the glove portion 190 to protect it from water damage.

As discussed above, the wearable device 100 offers three modalities of feedback to the user-visual, haptic and aural. When the user's hand approaches an object of interest that is not safe to touch, the visual indicators 122 on the wrist console 195 light up to alert danger. In addition, the wearable device includes switches 129 to select between haptic and aural modalities or disable either as per the user's desire. The wearable device 100 also includes one or more potentiometers connected to the audio indicator 126 and haptic indicator 124 to allow the user to fine-tune settings and increase or decrease the intensities of the feedbacks as required. In some embodiments, the potentiometers 128 can prevent audio or haptic intensities below a certain threshold meaning that it is not possible to make the audio indicator 126 inaudible or the haptic indicator 124 intensity to be too feeble to detect during normal operation.

In some embodiments, the wearable device 100 is intended to be used in the following manner. The wearable device 100 is waved in front of the object(s) for which the temperature needs to be determined and the non-contact sensor 114 will confirm the temperature with the appropriate feedback. If a set of objects are present, the individual objects can be touched by the contact sensors 112 located at the thumb, forefinger and middle finger to determine which of the objects is not safe to touch.

The wearable device 100 has a low latency to provide the user with feedback instantaneously which assists to decrease the risk of contact or to quickly remove the affected upper extremity from the harmful stimuli. The glove portion 190 is lightweight, breathable, and waterproof which allows users extended wear time, increased comfort and the ability to participate in their daily routines without interruption. There are three types of feedback responses—visual, haptic, and auditory. The feedback stimuli assist in compensating for the sensations that are lost while also stimulating and tapping into intact sensations. Each of the three feedback stimuli can be adjusted to match the user's abilities and preferences. Temperature can be detected by the invention when in close proximity and in direct contact, which further contributes to the user's safety.

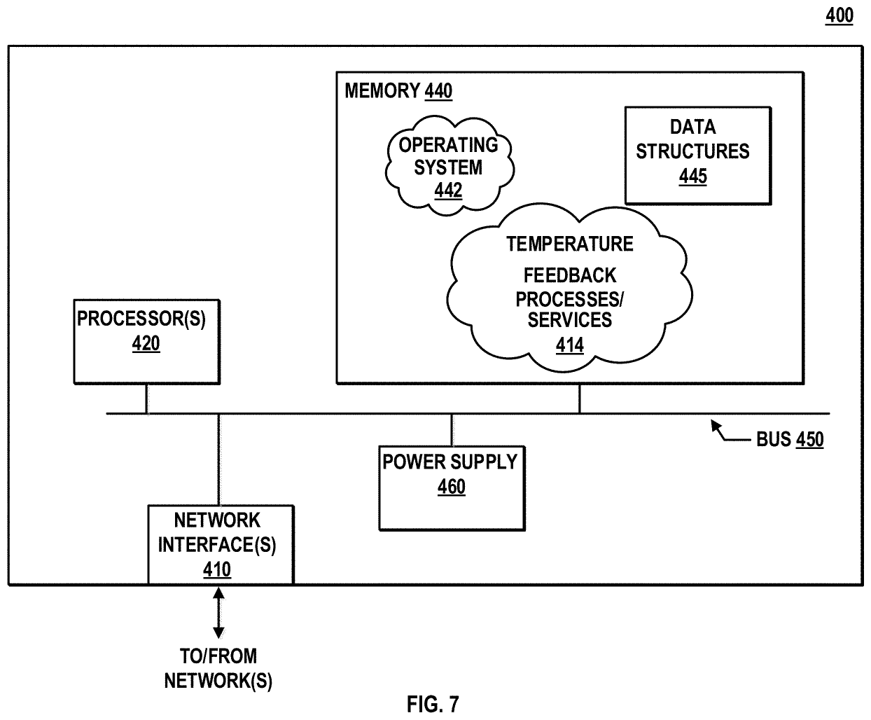

FIG. 7 is a schematic block diagram of an example device 400 that may be used with one or more embodiments described herein, e.g., as a component of system 100 and/or as controller 130 shown in FIG. 3.

Device 400 comprises one or more network interfaces 410 (e.g., wired, wireless, PLC, etc.), at least one processor 420, and a memory 440 interconnected by a system bus 450, as well as a power supply 460 (e.g., battery, plug-in, etc.).

Network interface(s) 410 include the mechanical, electrical, and signaling circuitry for communicating data over the communication links coupled to a communication network. Network interfaces 410 are configured to transmit and/or receive data using a variety of different communication protocols. As illustrated, the box representing network interfaces 410 is shown for simplicity, and it is appreciated that such interfaces may represent different types of network connections such as wireless and wired (physical) connections. Network interfaces 410 are shown separately from power supply 460, however it is appreciated that the interfaces that support PLC protocols may communicate through power supply 460 and/or may be an integral component coupled to power supply 460.

Memory 440 includes a plurality of storage locations that are addressable by processor 420 and network interfaces 410 for storing software programs and data structures associated with the embodiments described herein. In some embodiments, device 400 may have limited memory or no memory (e.g., no memory for storage other than for programs/processes operating on the device and associated caches).

Processor 420 comprises hardware elements or logic adapted to execute the software programs (e.g., instructions) and manipulate data structures 445. An operating system 442, portions of which are typically resident in memory 440 and executed by the processor, functionally organizes device 400 by, inter alia, invoking operations in support of software processes and/or services executing on the device. These software processes and/or services may include temperature feedback processes/services 414 described herein. Note that while temperature feedback processes/services 414 is illustrated in centralized memory 440, alternative embodiments provide for the process to be operated within the network interfaces 410, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the temperature feedback processes/services 414 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A wearable device, the wearable device comprising:
one or more thermal sensors operable for measuring a temperature value of ambient air or a temperature value of an object, the one or more thermal sensors being in communication with a feedback system, wherein the feedback system is operable to display one or more indications of temperature;
a glove portion in association with the one or more thermal sensors, wherein the glove portion is configured to receive a hand of a user and wherein the one or more thermal sensors are positioned on the glove portion; and
a controller in communication with the one or more thermal sensors and the feedback system, the controller being operable for receiving input from the one or more thermal sensors and causing the feedback system to indicate a temperature range in response to input corresponding to the temperature value measured by the one or more thermal sensors.

2. The wearable device of claim 1, wherein the one or more thermal sensors comprise:
a contact thermal sensor; and
a non-contact thermal sensor.

3. The wearable device of claim 2, wherein the contact thermal sensor is positioned on an index finger, a middle finger and/or a thumb of the glove portion.

4. The wearable device of claim 2, wherein the non-contact thermal sensor is positioned on a palm of the glove portion.

5. The wearable device of claim 1, wherein the wearable device further comprises:
a wrist console positioned on a wrist of the user and in electrical communication with the thermal sensor, wherein the wrist console houses the feedback system.

6. The wearable device of claim 1, wherein the indicators of the feedback system comprise one or more visual indicators. The wearable device of claim 6, wherein the visual indicator is operable to display a spectrum of colors, wherein a color of the spectrum of colors corresponds to a temperature range of a plurality of predetermined temperature ranges.

8. The wearable device of claim 1, wherein the indicators of the feedback system comprise one or more haptic indicators.

9. The wearable device of claim 8, wherein the haptic indicator is operable to display variable types of vibration feedback and wherein the vibration feedback corresponds to a temperature range of a plurality of predetermined temperature ranges.

10. The wearable device of claim 1, wherein the indicators of the feedback system comprise one or more audio indicators.

11. The wearable device of claim 10, wherein the audio indicator is operable to display variable types of audio feedback and wherein the audio feedback corresponds to a temperature range of a plurality of predetermined temperature ranges.

12. A method, comprising:
receiving, at a processor, a temperature value from a thermal sensor disposed along a surface of a glove portion and in communication with the processor;
classifying, by the processor, the temperature value according to one or more predetermined temperature ranges; and
providing an input to one or more indicators of a feedback system based on the temperature range associated with the temperature value.

13. The method of claim 12, wherein the one or more predetermined temperature ranges includes a first temperature range indicative of an extreme cold temperature.

14. The method of claim 12, wherein the one or more predetermined temperature ranges includes a second temperature range indicative of a safe temperature

15. The method of claim 12, wherein the one or more predetermined temperature ranges includes a third temperature range indicative of a heat warning temperature.

16. The method of claim 12, wherein the one or more predetermined temperature ranges includes a fourth temperature range indicative of an extreme heat temperature.

17. The method of claim 12, wherein the one or more indicators of a feedback system includes a visual indicator.

18. The method of claim 14, wherein the visual indicator includes an RGB LED.

19. The method of claim 14, wherein the visual indicator is operable to display a spectrum of colors, wherein a color of the spectrum of colors corresponds to a temperature range of a plurality of predetermined temperature ranges.

20. The method of claim 19, further comprising:
providing an input to the visual indicator to display a color according to the temperature range associated with the temperature value.

21. The method of claim 12, wherein the one or more indicators of a feedback system include an audio indicator.

22. The method of claim 21, wherein the audio indicator is operable to display variable types of audio feedback and wherein the audio feedback corresponds to a temperature range of a plurality of predetermined temperature ranges.

23. The method of claim 21, further comprising:
providing an input to the audio indicator to display audio feedback according to the temperature range associated with the temperature value

24. The method of claim 12, wherein the one or more indicators of a feedback system include a haptic indicator.

25. The method of claim 24, wherein the haptic indicator is operable to display variable types of vibration feedback and wherein the vibration feedback corresponds to a temperature range of a plurality of predetermined temperature ranges.

26. The method of claim 25, further comprising:
providing an input to the haptic indicator to display vibration feedback according to the temperature range associated with the temperature value.
